(19) United States
(12) Patent Application Publication
(10) Pub. No.: US 2002/0107713 A1
(43) Pub. Date: Aug. 8, 2002

(54) Requisition process and system

(76) Inventor: B. J. Hawkins, Marina Del Rey, CA (US)

Correspondence Address: LEVIN & HAWES, P O BOX 4140, LAGUNA BEACH, CA, 92652

(21) Appl. No.: 09/776,174

(22) Filed: Feb. 2, 2001

(51) Int. Cl. G06F 17/60

(52) U.S. Cl. 705/8

(57) ABSTRACT

A method and system is disclosed for requisitioning products and services in an organization. The method and system incorporates various best business practices into a flexible system that stream lines the requisitioning process. In one version the system and method is adapted to and takes advantage of a network computer system of an organization.

### FIELD OF THE INVENTION

The present invention relates to a process and system for administrative decision-making and more particularly to a system and process for approval of requests for products or services in an organization.

### BACKGROUND OF THE INVENTION

Every organization is held together and functions on the basis of preset and prescribed practices whether they be internally generated or follow some common pre-established form recognized as standard organizational practices. All organizations have procedures for obtaining approval for actions such as the purchase products and services. Over the years various optimal or best business practices have come into use. However, there has been up until the present a failure to identify all of these best business practices and integrate them into a unified system that optimizes the advantages provided by these best business practices. Requisitioning of products and services is one area in which the proper utilization of best business practices in a unified system can enhance the functioning of the organization and reduce cost, waste and fraud. Best business practices for such an organization include maintenance of a record of all relevant transactions for audit and other purposes, assuring that all individuals and departments within the organization that will be affected by the proposed requisition will receive timely and accurate notice of the proposed requisition and an ability to respond with comments and approval or disapproval as the case maybe.

In addition to developing a system that uses best business practices in an in an integrated and optimal fashion there is a need that such a system be adaptable to use in a wide variety of situations, including but not limited to an intranet or internet computer system. Most large and small organizations have or are in the process of reorganizing their structures and operations around a system of interconnected computers. These systems are generally connected together, often on a local area network in the form of an interoffice intranet. These systems can also be connected into large area networks that include computers in remote locations that are often connected together over the internet. Thus, any system that integrates the best business practices must as one of its criteria be fully capable of operating on a networked computer system.

### SUMMARY

It is an objective of the present invention is to provide a unified system and process that fully adapts all of the best business practices developed for requisitioning of products and services. It is a further objective of the present invention to provide a system and process that can be adapted to and fully utilized in many different types of situations including but not limited to a networked computer system.

The present invention accomplishes this and other objectives by providing a process for requisitioning products and services for an organization that includes the steps of: a) creating a requisition requesting a product or service; b) selecting one or more Reviewers to review and comment on the requisition; c) selecting one or more Approvers to review and approve the requisition; d) submitting the requisition to the one or more Reviewers for review and comment for a set terminating review period so that if a Reviewer fails to review and submit comments within the terminating review period the Reviewer is deemed to agree to the requisition as presented; e) submitting the requisition to the one or more Approvers for review and approval; f) submitting the requisition for effectuation upon receipt of approval from all of the Approvers; and wherein the steps of the process are all competed in a timely and efficient manner. In a further aspect of the invention the step of submitting the requisition is made simultaneously to the all of the Reviewers but to each of the Approvers it is submitted sequentially.

In yet a further aspect of the process of the invention it includes the additional steps of: a) revising the requisition upon receipt of comments from a Reviewer or Approver; b) withdrawing the requisition from consideration while it is being revised; and c) resubmitting the revised requisition to all of the Reviewers and Approvers.

In yet another aspect of the invention it retains a permanent record of all transactions involving the requisition to assure a record is retained for audit and other purposes.

In another aspect of the invention it provides a system for managing product and service procurement of an organization that can be adapted to and used on a networked computer system of an organization that includes: a) a network of computers interactively linked, with each computer assigned a unique address; b) data storage accessible to all of the computers on the system; c) procurement protocol available to the system that provides for the classification of individuals within the organization as Originators of requisitions for procurement requests, Reviewers of requisitions or Approvers of requisitions and wherein each individual has a unique electronic correspondence address in the system, and a detailed record of all the transactions concerning the requisition are permanently saved in data storage in an unalterable format; d) the procurement protocol allows an individual classified as an Originator to prepare a requisition and forward it electronically, by e-mail, through the system to one or Reviewers and one or more Approvers selected by the Originator; e) the protocol sets a specific time period in which the one or more Reviewers can respond with comments by an electronic message and upon a failure to do so it enters a record on the database of acquiescence to the requisition by Reviewer who fails to respond; f) the protocol allows each Approver to respond by an electronic message with an approval or disapproval of the requisition and comments; g) upon receiving a response from the at least one Reviewer or Approver the protocol allows the Originator to either continue with the requisition as originally drafted, withdraw it from consideration for revision and resubmission or to withdraw it without resubmission; and h) wherein the protocol also saves a locked immutable electronic version of the requisition and responses of the at least one Reviewer and at least one Approver for audit purposes of the organization. The system also saves complete record of all transactions involving the requisition for audit and similar purposes.

### BRIEF DESCRIPTION OF THE DRAWINGS

The invention will be better understood by an examination of the following description, together with the accompanying drawings, in which:

FIG. 1 is a flow that shows the overall functional frame work of the present invention;

FIG. 2 is a schematic block diagram of an organizations computer system with internet access on which one version of a preferred embodiment of the present invention can operate when appropriately adapted;

FIG. 3A is a detailed flow chart of the requisition drafting function of the present invention;

FIG. 3B is a detailed flow chart of the review and approval process of a pending requisition; and

FIG. 4 is a schematic block diagram of the structural components of the present invention.

### DETAILED DESCRIPTION OF THE PREFERRED EMBODIMENT

I. Overview:

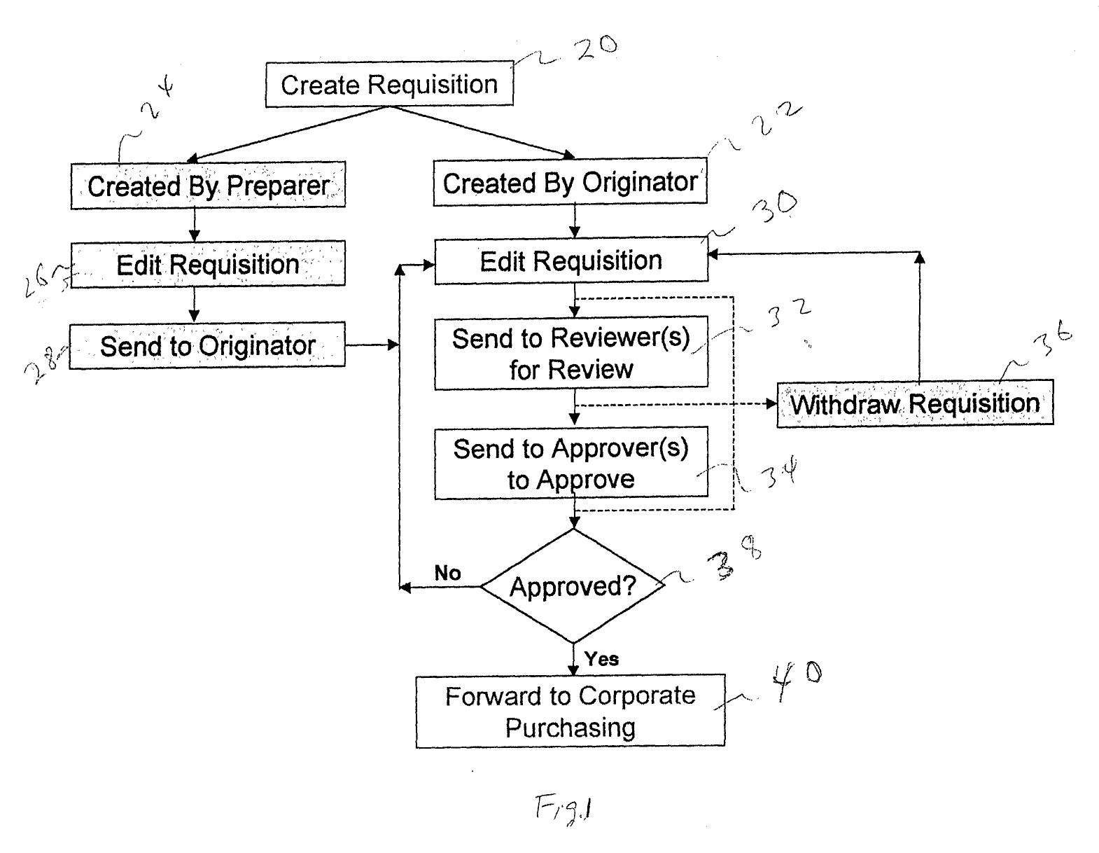

FIG. 1 provides a broad overview of the process of the present invention. The first step 20 is the determination to create a requisition. Generally the Originator of a requisition will be making the request for some organizational purpose, be it the purchase of supplies, obtaining of services of an outside contractor etc. The Originator, perhaps a manager or an executive of the organization, may prepare 22 the requisition. However, more typically the Originator will have subordinates, a Preparer, to whom the Originator will delegate 24 the preparation of the initial draft of the requisition for the product or service. The request would typically include an outline of information necessary for the Preparer to draft the requisition. The Preparer would draft and edit the requisition 26 and then send the draft to the Originator 28 for review. In turn the originator will edit the requisition 30 and send it on to selected Reviewers 32 and Approvers 34 in the organization. If a Reviewer submits comments on the requisition the Originator has the option of withdrawing the requisition 36, editing it 30 and resubmitting it 32 and 34. The Approver makes the final decision to approve or not 38. If the Approver approves the pending requisition it is forwarded to purchasing 40. If the Approver does not approve the requisition it is returned to the Originator for editing and resubmission.

The system is very flexible in that it can let the Preparer select the individuals in the organization who will be Reviewers and Approvers. Alternatively, the system and process could be structured such that the Preparer would have to designate Approvers and Reviewers from preset lists.

Reviewers will generally be individuals within the organization who have, by virtue of their position or department, some interest in the items being requisitioned and who's comments and recommendations could be very helpful in shaping the final form of the requisition and help avoid waste or mistakes in the process. However, the Reviewer would not have veto power over the requisition. For the sake of efficiency the requisition would be sent to all Reviewers simultaneously and they would be given a set period of time to respond with their comments. Failure to respond within the preset period of time would be taken as an indication the Reviewer has no objections or recommendations with respect to the requisition and that the Reviewer is in agreement with it. The system also allows the Preparer to withdraw the requisition and revise it based on comments received from a Reviewer.

On the other hand, requisitions would be sent to Approvers in a preset sequential order. If an Approver rejects a requisition it would be returned to the Preparer. The Preparer would then have the option of revising and resubmitting it or withdrawing it. The system does provide the option of allowing the requisition to be sent to more than one Approver at a time.

If the organization generally has preset cycles or periods when requisitions can be submitted the system has the capability of allowing the requisition to be submitted outside of this cyclical time frame. The system and process of the present invention also provides for retention of a record of all transactions concerning the requisition. This record is retained in a secure unalterable format for audit, control and other purposes.

II. An Example Of A Preferred Embodiment:

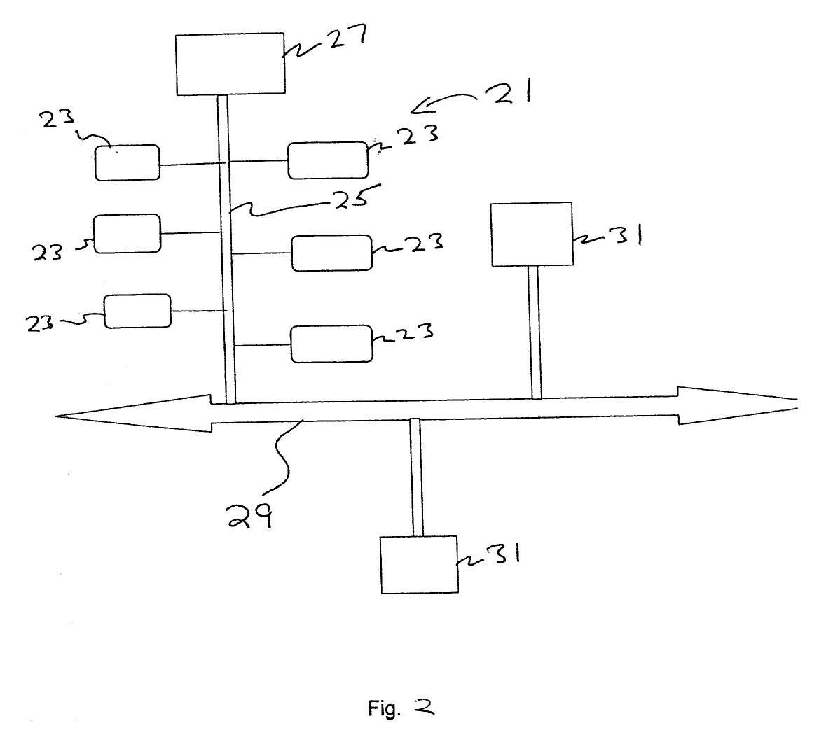

Most organizations, governmental, business, educational etc., be they large or small, have or are in the process of restructuring their operations around personal computers operating on a network 21 (FIG. 2). Employees in these organizations, from clerical to executive, generally each have their own computer workstations 23 consisting of a personal computer connected to a network 25. Additionally, these systems include a server 27 with accessible data files and shared software programs. These systems 21 in turn are generally connected to the internet 29 to allow the employee to access various resources 31 available over the internet. Additionally, each employee has there own unique electronic address, generally an e-mail address that is part of an electronic mail system, that allows the employee to communicate electronically with those within the organization. The employee can also communicate by e-mail with persons outside of the organization who are connected to the internet and have an e-mail address.

A. The Process:

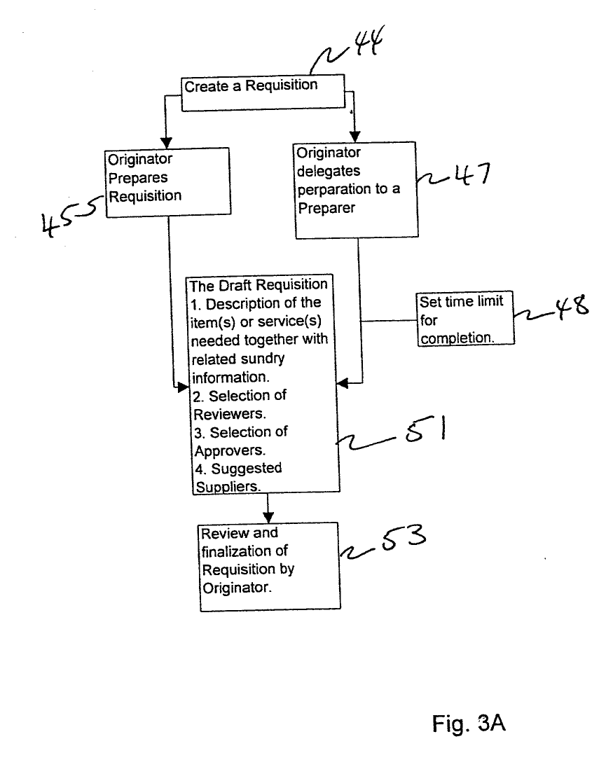

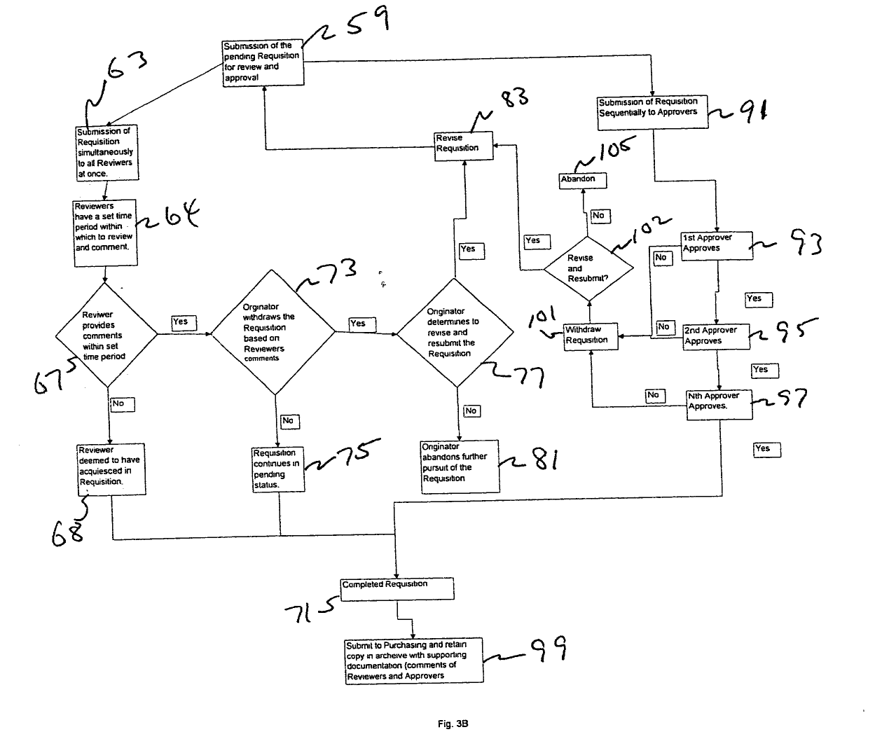

FIGS. 3A and 3B provide a detailed view of the process of the present invention. The first step is a determination to create a requisition 44. Once the Originator decides to create the requisition he will either do it himself 45 or delegate it to a subordinate 47 identified by the system as a Preparer. If the Originator delegates it to a Preparer the Originator can then set a time limit 48 within which the Preparer must complete the draft requisition. The actual requisition 51 once prepared will include: 1) a description of the product(s) or service(s) needed, 2) the purpose, 3) those in the organization that must review the requisition Reviewers, 4) those who must approve the requisition Approvers and 5) suggested suppliers. This is only a partial list of what can be included in a requisition and the system would allow for the tailoring of the requisition to the specific needs of an organization. The system and process allows the Preparer or Orginator to add detailed comments to the requisition as well as pertinent documents relating to the requisition.

A Reviewer may be someone who has special knowledge that can be of assistance in making the decision on the requisition or who may be affected by the requisition and whose input will be helpful. In the present invention a Reviewer's approval is not necessary for the requisitions final approval for action. The system can include a list of Reviewers from which the Originator can or must select Reviewers given the type of product or service being requested. The system could also be designed to allow the Originator to select only those whose input the Originator deems necessary for an effective decision. As will be noted again below the preferred embodiment of the invention will give each Reviewer a set time period to review and comment by e-mail. If the Reviewer fails to do so the Reviewer will be deemed to have acquiesced in the requisition as presented. One of the important and unique features of the present invention is that the Reviewer can add detailed comments and documents to the requisition. The Reviewer then submits these comments to the Orginator for the Orginators review and consideration. The Originator then has the option of acting on the comments by withdrawing and revising the requisition as that Orginator deems necessary.

An Approver typically is someone in management who has authority to authorize expenditures by the organization to obtain products or services. The system of the present invention will require the affirmative approval of all Approvers listed for the requisition. The Approver can be the superior of the Originator or any other person in authority. The system can also provide a list of Approvers from which the Originator can or must select Approvers for the requisition. Naturally, if the system requires certain Approvers or Reviewers the system can provide a warning to the Originator that the required Reviewers or Approvers have not been selected during the drafting process.

The system can include the additional feature of allowing the Originator to recommend as part of the requisition preferred suppliers of the product or service 51. As noted above the requisition can also include any other information deemed necessary by the organization for review and approval of a requisition.

After completion of the draft requisition, whether by a Preparer or the Originator, the Originator has final responsibility for reviewing and finalizing it 53. Once this has been done it can be then become a pending requisition and sent for review and approval by e-mail to the selected Reviewers and Approvers. In the preferred embodiment of the system only a person with the designation of an Originator will be able to finalize and send a requisition onto the system for review and approval. As noted above and will be explained in more detail below each person with access to the system is given a security access code and a category in the system that defines what they can and can not do on the system, i.e. Reviewer, Approver, Originator, Preparer etc. The system and process of the present invention will have as part of its operational structure built in controls to assure the integrity of the system is maintained.

Referring again to FIG. 3B, the Originator's finalization of the requisition turns it into a pending requisition when the Originator submits it by e-mail for review and approval 59. In the preferred embodiment, the requisition is submitted simultaneously to all of the selected Reviewers 63. The Reviewers will have a set time period 64 within which to review it and respond with comments. The time period be it days, a week or otherwise can be set at the convenience and need of the organization. The system is designed to put the affirmative burden on the Reviewer to timely review and comment on the requisition. If the Reviewer fails to review and comment in the time set, the Reviewer will be deemed to have agreed with the requisition in all of its particulars. Whether or not the Reviewer reviews and comments in a timely fashion, the system will retain as part of the archived record the fact that the Reviewer received a copy by e-mail. It will also retain a record of any responses submitted by the Reviewer.

One of the important aspects of the system and process of the present invention is to prevent the requisition from bogging down in the inertial present in an organization and avoid the difficulties always present when several persons in the organization have to review and comment on something. Additionally, by retaining a record of who the requisition has been sent to and when, it prevents individuals from avoiding their responsibilities to take timely action on such matters for the organization and later say they never saw it. Additionally, as the preferred embodiment is described herein, it eliminates the total need for a paper based intra-office mail system and the waste, inefficiency and expense of the same.

Thus, if the Reviewer does not respond 67 he or she is deemed to have acquiesced 68 in the requisition and one of the requirements of a completed requisition 71 has been met. On the other hand if the Reviewer provides timely comments by responding, by e-mail, it is then up to the Originator to review these comments and make a decision as to whether or not the requisition should be withdrawn and revised in view of the comments 73. The Originator is not under an obligation to do so and can allow the requisition to continue as a pending requisition 75, the review requirement having been met thus completing one of the requirements for a completed requisition 71. If the Originator determines, based on the Reviewers comments, to withdraw the requisition, then he or she must determine if it should be revised and resubmitted 77. If the Originator, for whatever reason, decides not to revise and resubmit, the requisition would become abandoned 81. If the Originator decides to revise 83 he or she would then resubmit it 59 starting the process over again. As pointed out above and emphasized below, all during this process a locked permanent record of the process is being created for current and later review. Such a locked permanent record provides an audit trail for management to determine what precisely happened during the process if problems later occur. Additionally, better business practices and in many instances regulations and laws, in particular those involving governmental and quasi-governmental organizations, require the retention of such records for audit and other purposes. The saved locked record naturally will include the comments or failure to comment by Reviewers as noted previously. Thus, a Reviewer and management can be assured that a responsible Originator will carefully consider comments of a Reviewer and determine if they warrant a revision of the requisition.

Referring again to FIG. 3B, in the preferred embodiment, at the same time the requisition is submitted to the Reviewers it is submitted to the selected Approvers. However, with respect to the Approvers, if more than one has been selected, either from a list of required Approvers or arbitrarily by the Originator, the requisition in the preferred embodiment is submitted sequentially to the Approvers 91. Thus, it will be submitted to the first Approver 93, if approved it will be submitted to the second Approver 95 and if again approved it will be submitted to the next Approver until it reaches the Nth Approver 97, where if it is approved it becomes a completed requisition 71 ready to be submitted to the organizations purchasing department 99. On the other hand if at any point it is rejected by an Approver it is automatically withdrawn 101. When this happens the Originator has to determine if he or she wants to revise and resubmit the requisition 102. The Originator has the option of abandoning it 105 or revising 83 it and resubmitting it 59 through the same process.

The system saves in a locked format a record of all approvals, disapprovals, revisions and comments made as part of the permanent archive. The permanent record as noted above provides an audit trail for future reference.

B. The Structure:

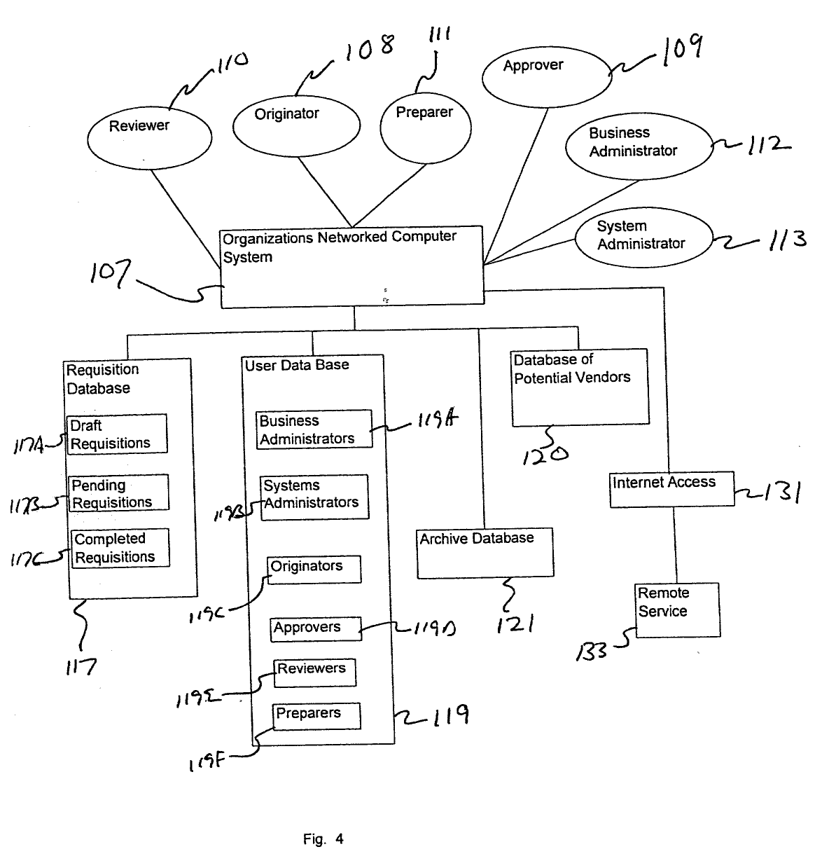

FIG. 4 provides a schematic block type diagram of the preferred embodiment of the structure of the major component parts of the present invention. As noted above, the system of the preferred embodiment as described herein, is centered on the networked computer system 107 of the organization using the invention. Each of the employees of the organization appears to the system in one or the more of the roles as Originators 108, Approvers 109, Reviewers 110 or Preparers 111. As noted above, each of these categories have their role within the system. They allow the person with the designated category to function as described above. The system in its preferred embodiment has two additional categories that of Business Administrator 112 and Systems Administrator 113. The Business Administrator is an organization management function and a person with this classification will have access to the current status of draft, pending and completed requisitions. The Business Administrator will also have access to the archived record. The Business Administrator 112, a person or persons fairly high in management will have the need for access to current and past records of requisitions for a variety of reasons. They could include the need to determine on going purchasing expenses of the organization, work being done by various employees or any other of a number of reasons. The Systems Administrator 113 is the person or persons responsible for running the computer system of the organization and related systems. His or her need for access generally relates to the proper functioning of the system. In the preferred embodiment of the present invention, once a record has become locked and saved no one can change or alter the locked records. This prevents tampering with important records and preserves them for their audit and control purposes.

The preferred embodiment of the invention has a number of databases to maintain and protect records. One of the primary databases is the Requisition database that in the preferred embodiment has several sub-databases. Among these are the Draft Requisition database 117A, where requisitions in draft form, ie. those in the stage of being prepared, are saved. Once a requisition is completed and is sent to the Reviewers and Approvers it becomes a pending requisition and according becomes part of the Pending database 117B. Finally, once the requisition has been reviewed, approved and is sent onto purchasing for action it becomes a completed requisition and is saved in the Completed Requisitions database 117C.

Another important database category is the User database 119. This database in the preferred embodiment retains information regarding the categorization of each of the employee users of the system. This information would include the unique e-mail address of each person as well as passwords together with the classification or classifications each person has within the organization, i.e. Business Administrator 119A, Systems Administrator 119B, Originator 119C, Approver 119D, Reviewer 119E and Preparer 119F. Additionally the database record could include special information or authorizations of each person within the system.

The system might have additional databases of potential vendors 120 that an Originator can refer to as possible vendors on a requisition. Indeed any number of additional databases can be added as needed or desired to work in the system.

A database of Archived Records 121 contains all of the records relating to past requisitions and related records, i.e. approvals, comments etc. It can also contain a record of actions related to this requisition after it is sent to purchasing.

The system would typically have access to the internet so that the users of the system can access resources on the internet. They can also receive e-mails from persons on the internet 131.

The software on which the system could be either accessible on a remote server 133 over the internet 131 or directly available on the local server of the organizations computer system. This specification has described the invention at the modeling or functional level. No specific software code or language has been mentioned. However, when a person of ordinary skill in the art has read and understands the concepts of this invention they should be able to implement the invention in a variety of software programs without undue experimentation. The invention described herein could operate as a separate standalone system or as part of an over all procurement system that would also function with a system that would solicit bids from potential suppliers of services and products. Such a companion system could be like that described in copending application entitled “An Automated Bidding Process and System” Ser. No. ______ filed ______, which application is incorporated herein by reference.

While the invention has been particularly shown and described with reference to a preferred embodiment thereof, it will be understood by those skilled in the art that various changes in form and detail may be made to it without departing from the spirit and scope of the invention.

1. A process for requisitioning products and services in an organization comprising the steps of:
a) creating a requisition requesting a product or service;
b) selecting at least one reviewer to review and comment on said requisition;
c) selecting at least on approver to review and approve said requisition;
d) submitting said requisition to said at least one reviewer for review and comment for a set terminating review period so that if the reviewer fails to review and submit comments within the terminating review period said reviewer is deemed to agree to said requisition as presented;
e) submitting the requisition to said at least one approver for review and approval; and
f) submitting said requisition for effectuation upon receipt of approval from said at least one approver.

2. The process of claim 1 including the further steps of:
a) revising said requisition upon receipt of comments from said at least one reviewer or said at least one approver;
b) withdrawing said requisition from consideration while it is being revised; and
c) resubmiting said revised requisition to said at least one reviewer and said at least one approver.

3. The process of claim 1 including the further steps of:
a) assigning preparation of said requisition to a Preparer by an originator of said requisition;
b) preparing of a draft requisition by said preparer;
c) reviewing by said originator of said draft request; and
d) finalizing said requisition by said originator for submission to said at least one reviewer and said at least one approver.

4. A process for requisitioning products and services on a networked computer system of an organization comprising the steps of:
a) creating a requisition requesting a product or service;
b) selecting at least one reviewer to review and comment on said requisition;
c) selecting at least on approver to review and approve said requisition;
d) submitting said requisition to said at least one reviewer for review and comment for a set terminating review period so that if the reviewer fails to review and submit comments within the terminating review period said reviewer is deemed to agree to said requisition as presented;
e) submitting the requisition to said at least one approver for review and approval;
f) submitting said requisition for effectuation upon receipt of approval from said at least one approver; and
wherein said steps of said process are all competed on the computer system and the step of submitting said requisition is made simultaneously to said at leas one reviewer and said at least one approver on said computer system.

5. The process of claim 4 including the further steps of:
a) revising said requisition upon receipt of comments from said at least one reviewer or said at least one approver;
b) withdrawing said requisition from consideration while it is being revised; and
c) resubmiting said revised requisition to said at least one reviewer and said at least one approver.

6. The process of claim 4 including the further steps of:
a) assigning preparation of said requisition to a Preparer by an originator of said requisition;
b) preparing of a draft requisition by said preparer;
c) reviewing by said originator of said draft request; and
d) finalizing said requisition by said originator for submission to said at least one reviewer and said at least one approver.

7. The process of claim 5 including the further steps of:
a) including a security system on the computers system;
b) assigning said originator, said preparers said at least one approver and said at least one reviewer each security code for access to the computer system; and
c) assigning said originator, said preparer, said at least one approver and said at least one reviewer each a preset address for access to and receipt of requisitions and responses to requisitions over the computer system.

8. The process of claim 4 wherein the step of submitting said requisition to at least one approver further comprises submitting said requisition sequentially according to a preset order to at least two approvers and wherein if one of said approvers does not approve said requisition it is immediately returned to said originator for further action.

9. The process of claim 4 comprising the further step of locking into memory of said computer system an audit trail of pre-determined steps in each specific process for requisitioning products and services.

10. The process of claim 4 including the further steps of:
a) withdrawing said requisition from consideration upon receipt of a rejection from said at least one approver;
b) revising said requisition; and
c) resubmiting said revised requisition to said at least one approver for reconsideration.

11. The process of claim 4 including the further step of providing access to status reports of said requisition in real time.

12. The process of claim 4 wherein the step of submitting said requisition to at least one approver comprises selecting said at least one approver and then submitting it to said at least one approver.

13. The process of claim 12 wherein the step of selecting at least one approver further comprises selecting a plurality of approvers and setting a sequential order in which each of the plurality of approvers will review said requisition.

14. The process of claim 4 wherein the process of submitting said requisition to at least one reviewer comprises selecting at least on reviewer and submitting it to said one reviewer.

15. The process of claim 4 wherein the step of selecting at least one reviewer comprises selecting a plurality of reviewers and submitting it simultaneously to the plurality of reviewers.

16. A system for managing product and service procurement of an organization on a networked computer system of the organization comprising:
a) a network of computers interactively linked, with each computer assigned a unique address;
b) data storage accessible to all of said computers on said system;
c) procurement protocol available to said system that provides for the classification of individuals within the organization as originators of requisitions for procurement requests, reviewers of requisitions or approvers of requisitions and wherein each individual has a unique electronic correspondence address in said system, and all of said information being savable in said data storage;
d) said requisition protocol allows an individual classified as an originator to prepare a requisition and forward it electronically through said system to at least one reviewer and at least one approver selected by said originator;
e) said protocol sets a specific time period in which said at least one reviewer can respond with comments by an electronic message and upon a failure to do so it enters a record on the database of acquiescence to said requisition by said at least one reviewer;
f) said protocol allows said approver to respond by an electronic message with an approval or disapproval of said requisition and comments;
g) upon receiving a response from said at least one reviewer or approver said protocol allows said originator to either continue with the requisition as originally drafted, withdraw it from consideration for revision and resubmission or to withdraw it without resubmission; and
h) wherein said protocol also saves a locked immutable electronic version of said requisition and responses of said at least one reviewer and at least one approver for audit purposes of said organization.

17. The system of claim 16 including the further classification of individuals as preparers with their own electronic address is said system and to which said originators may delegate preparation of a requisition.

18. The system of claim 16 including the further classification of individuals as administrators with access to check the status of currently active requisitions and to access and review achieved requisitions and related data.

19. The system of claim 16 wherein each individual classified as an originator has a preset at least one approver to whom said requisition must be submitted for approval.

20. The system of claim 16 wherein said computer system has access to an internet of connected computers outside of said organization and said requisition protocol is accessed on a computer attached to the internet.

21. The system of claim 16 wherein said protocol is accessible on a local system of said organization.

22. The system of claim 16 wherein when said requisition is classified into one of three different categories of draft requisitions for requisitions being prepared or revised, pending requisitions for requisitions that have been submitted to at least on reviewer and at least one approver and completed requisitions for requisitions that have completed the review process and have been approved by at least one approver.

23. The system of claim 22 wherein said requisitions are saved in one of three databases: draft, pending and completed databases depending on said requisitions then classification.

24. The system of claim 16 wherein if said at least one reviewer is more than one reviewer said requisition is submitted simultaneously to said more that one reviewer.

25. The system of claim 16 wherein if said at least one approver is more than one approver said requisition is submitted sequentially to said more than one approver.

26. The system of claim 25 wherein when said requisition is submitted sequentially to said more than approver it is submitted in accordance with a predetermined sequential list of approvers.
